(19) United States
(12) Patent Application Publication
(10) Pub. No.: US 2013/0188588 A1
(43) Pub. Date: Jul. 25, 2013

(54) Signaling for Configurable Dual-Cluster Resource Assignments

(71) Applicants: Esa Tapani Tiirola, Kempele (FI); Kari Juhani Hooli, Oulu (FI); Kari Pekka Pajukoski, Oulu (FI); Xiaoyi Wang, Beijing (CN)

(72) Inventors: Esa Tapani Tiirola, Kempele (FI); Kari Juhani Hooli, Oulu (FI); Kari Pekka Pajukoski, Oulu (FI); Xiaoyi Wang, Beijing (CN)

(73) Assignee: Nokia Siemens Networks Oy, Espoo (FI)

(21) Appl. No.: 13/806,174

(22) PCT Filed: Jun. 21, 2010
(86) PCT No.: PCT/CN2010/000897

§ 371 Date: Mar. 19, 2013

(51) Int. Cl. H04W 72/04

(52) U.S. Cl. CPC H04W 72/0453
USPC 370/329

(57) ABSTRACT

A virtual resource block VRB tree is configured according to granularity of resource blocks RBs, cluster size options and frequency span, at least one of which is signaled on a downlink A first cluster of RBs is identified by a first resource allocation RA index and selected from the configured VRB tree. A second cluster of RBs, separated in frequency from the selected first cluster of RBs and identified by a second RA index, is selected from the configured VRB tree. The selected first and second clusters of RBs selected from the configured VRB tree is mapped to respective first and second clusters of uplink physical RBs. Certain frequency band combinations of two RB clusters may be made illegal for various reasons. The granularity of RB may be Me {1, 2, 3, 4} physical RBs, and the cluster size options may be an integer k multiple of M.

### TECHNICAL FIELD

The exemplary and non-limiting embodiments of this invention relate generally to wireless communication systems, methods, devices and computer programs and, more specifically, relate to signaling clustered allocations of radio resources such as for example dual-cluster allocations in the LTE system.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:

3GPP 3rd generation partnership project

BW bandwidth

DCI downlink control information

eNB evolved Node-B

LTE long term evolution

PDCCH physical downlink control channel

PRB physical resource block

PUSCH physical uplink shared channel

RA resource allocation

RRM radio resource management

SRS sounding reference signal

UE user equipment

VRB virtual resource block

WCDMA wideband code division multiple access

Further advancements to the LTE communication system, expected to be implemented as Release 10, include allocating to UEs PRBs on the PUSCH that are clustered. Current discussions consider that the network should be able to allocate at least two distinct clusters, but how to signal such allocations are not yet resolved.

Resource assignments in LTE Release 8/9 allow allocation of a frequency-continuous set of resources as set forth at 3GPP 36.213 v9.1.0 (2010-December), sec 8.1, which describes signaling an indication of number of PRBs being allocated and a ‘start offset’. This prior art approach needs (┌log₂(N_{RB}^{UL}(N_{RB}^{UL}+1)/2)┐) signaling bits to indicate these two values, and FIG. 1 shows the number of RA bits required with different bandwidth options.

It is anticipated that Release 10 will use different size clusters and will require the ability to signal at least two different clusters when giving a resource allocation to a UE. What is needed in the art is a way to signal such clustered PRBs to a UE without using excessive signaling overhead.

### SUMMARY

The foregoing and other problems are overcome, and other advantages are realized, by the use of the exemplary embodiments of this invention.

In a first aspect thereof the exemplary embodiments of this invention provide a method, comprising: configuring a virtual resource block tree according to granularity of resource blocks and cluster size options and frequency span, with at least one configuration parameter signaled on a downlink; selecting from the configured virtual resource block tree a first cluster of resource blocks that is identified by a first resource allocation index; selecting from the configured virtual resource block tree a second cluster of resource blocks that is separated in frequency from the selected first cluster of resource blocks and that is identified by a second resource allocation index ; and mapping the selected first and second clusters of resource blocks selected from the configured virtual resource block tree to respective first and second clusters of uplink physical resource blocks.

In a second aspect thereof the exemplary embodiments of this invention provide a memory storing a program of computer readable instructions, that when executed by at least one processor result in actions comprising: configuring a virtual resource block tree according to granularity of resource blocks and cluster size options and frequency span, at least one of which is signaled on a downlink; selecting from the configured virtual resource block tree a first cluster of resource blocks that is identified by a first resource allocation index; selecting from the configured virtual resource block tree a second cluster of resource blocks that is separated in frequency from the selected first cluster of resource blocks and that is identified by a second resource allocation index; and mapping the selected first and second clusters of resource blocks selected from the configured virtual resource block tree to respective first and second clusters of uplink physical resource blocks.

In a third aspect thereof the exemplary embodiments of this invention provide an apparatus, comprising at least one processor and at least one memory storing computer program code. The at least one memory and the computer program code are configured, with the at least one processor, at least to: configure a virtual resource block tree according to granularity of resource blocks and cluster size options and frequency span, at least one of which is signaled on a downlink; select from the configured virtual resource block tree a first cluster of resource blocks that is identified by a first resource allocation index; select from the configured virtual resource block tree a second cluster of resource blocks that is separated in frequency from the selected first cluster of resource blocks and that is identified by a second resource allocation index ; and map the selected first and second clusters of resource blocks selected from the configured virtual resource block tree to respective first and second clusters of uplink physical resource blocks.

These and other aspects of the invention are detailed with more particularity below.

### BRIEF DESCRIPTION OF THE DRAWINGS

FIG. 1 is a chart showing number of resource allocation bits bits needed to signal clustered PRBs in LTE Release 8/9 DCI Format 0.

FIG. 2 is a VRB tree structure for K=8 according to an exemplary embodiment of the invention.

FIG. 3 is an RA indexing protocol for the first cluster which overlies the VRB tree structure of FIG. 2 according to an exemplary embodiment of the invention.

FIG. 4 is the VRB tree from FIG. 3 re-indexed from the end of the first cluster for mapping the second cluster from the same VRB tree according to an exemplary embodiment of the invention.

FIG. 5A is similar in concept to FIG. 4 and showing shaded areas in which the second cluster must be located which is restricted by L=5, according to an exemplary embodiment of the invention.

FIG. 5B is also similar to FIG. 5A and showing shaded areas in which the second cluster must be located which is restricted by L=5 and further by N2=25, according to an exemplary embodiment of the invention.

FIG. 6A is similar in concept to FIG. 4 and showing indexes for both the first and the second resource allocation clusters on the same tree at the same time according to another exemplary embodiment of the invention.

FIG. 6B is similar to FIGS. 5A-B in that is shows indexing for only the second resource allocation cluster on the VRB tree only on allowed tree branches indicted by signaling, according to another exemplary embodiment of the invention

FIG. 7 is a VRB tree for M=2, N=41, K=10 and O=10 according to an exemplary embodiment of the invention.

FIG. 8 is a chart showing allowed/legal versus prohibited/illegal cluster size combinations based on DFT size limitations of LTE Release 8, according to an exemplary embodiment of the invention.

FIGS. 9A-B are respective configurations for L₁=2 and L₂=4 for the first and second resource allocation clusters, according to an exemplary embodiment of the invention.

FIGS. 9C-D are also respective configurations for L₁=2 and L₂=4 for the first and second resource allocation clusters, according to another exemplary embodiment of the invention.

FIG. 10 is a diagram illustrating cluster starting positions for L=2 and L=4 and k={1, 2, 4, 6, 12} according to an exemplary embodiment of the invention.

FIG. 11 is a diagram showing a resource allocation according to an exemplary implementation of a second embodiment of the invention.

FIG. 12 is a series of charts showing cluster bandwidth options and corresponding total bandwidths with vector k, according to an exemplary embodiment of the invention.

FIG. 13 is a logic flow diagram that illustrates, in accordance with an exemplary embodiment of this invention, the operation of a method, and a result of execution of computer program instructions embodied on a computer readable memory.

FIG. 14 shows a simplified block diagram of various electronic devices that are suitable for use in practicing the exemplary embodiments of this invention.

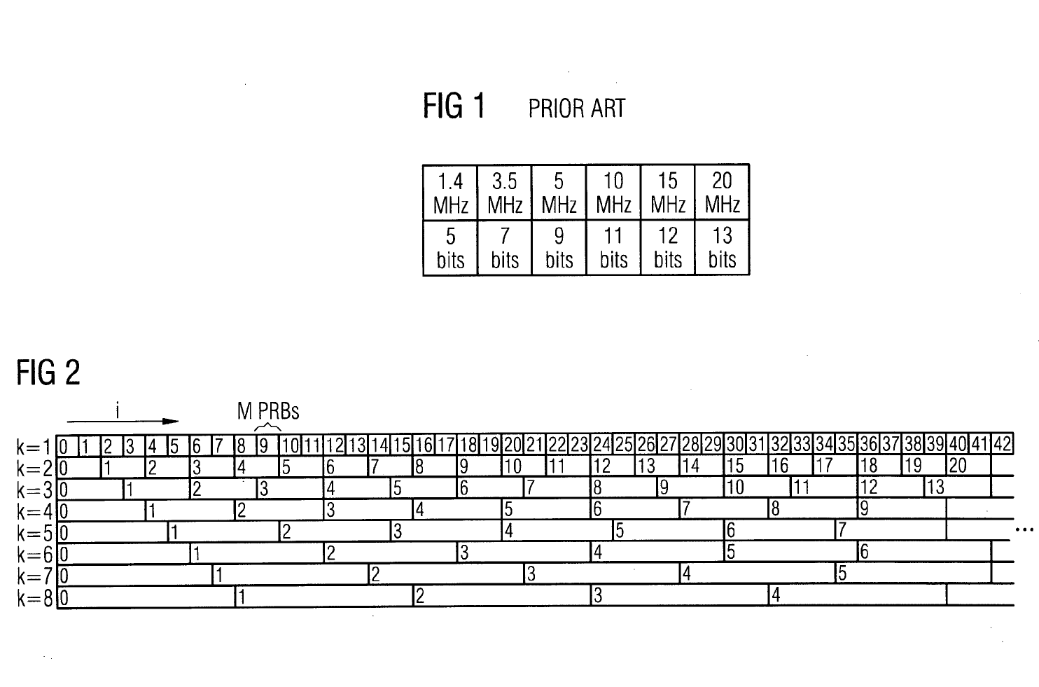

### DETAILED DESCRIPTION:

The invention is explained hereinafter by way of examples which are illustrating of but not limiting to the extent of these teachings. That is, while the examples are given as specific embodiments of the invention, the invention is not limited to only these embodiments and is adaptable to many varied environments which may even be dis-similar to those of these examples.

Embodiments of the invention entail a scheme for indexing resource allocations and a corresponding signaling arrangement which can be used to allocate at least two clusters of PRBs on an uplink channel such as for example the PUSCH in LTE. This indexing scheme is configurable to support different size clusters, to ensure some frequency separation between the clusters being allocated and to trade-off between signalling flexibility and scheduling bandwidth of clustered allocation. While the exemplary embodiments below detail allocating two clusters, the principles are readily extended for allocating more than only two clusters.

Exemplary embodiments of the invention can be broken into three distinct concepts for purposes of this description, as set forth below.

First, the possible cluster positions and bandwidths are reduced while maintaining the capability to allocate resources across the entire system bandwidth. This is done in an embodiment by defining parameter M and vector k. Parameter M specifies the minimum cluster size and therefore corresponds to the bandwidth granularity. In an exemplary embodiment the parameter M is independent of the system bandwidth, and in a most particular embodiment M∈ {1, 2, 3, 4} PRBs. It is also possible define M separately for different system bandwidths, e.g., in such that M∈ {1, 2} for small system bandwidths and M∈ {2, 3, 4} for large system bandwidths. Vector k [k₁,k₂, . . . , k_{K}] defines the cluster size options (kM) which are applicable. Further in this first concept the possible cluster positions are reduced further or the possible cluster and bandwidth combinations are reduced. These are detailed further below as respective first and second embodiments.

Second, there is a mechanism or means to adjust position of a clustered RA in frequency, for example to match the frequency position with that of a sounding reference signal SRS tree. In an embodiment this is implemented by a parameter 0, which equals to the PRB offset of a VRB tree, with respect to a pre-defined reference point. In a particular embodiment this reference point corresponds to PRB number 0 since that is simplest for explanation, but the pre-defined reference point can be any PRB.

The first and second steps define possible cluster positions in frequency.

Third, there is an indexing scheme provided for clustered resource allocation in which the position and/or the level of the VRB tree of the second cluster is defined relative to the position of the first cluster. In the examples detailed below, this indexing scheme is both scalable and supports multiple configurations.

First embodiment: Above it was noted that there are example for two different embodiments for how to reduce possible cluster positions further. Reducing the possible cluster positions enables the per-allocation signaling to be reduced. In this first embodiment which is particularly useful for larger cluster BWs the possible cluster positions are reduced by means of a VRB tree that is applicable to clustered RA with an unlimited frequency size/unlimited BW. Two implementations of this first embodiment are presented.

In a first implementation the indexing scheme for clustered resource allocation is provided by the following steps.
a. Define parameter N, which is the size of PRB tree when counted as numbers of M-sized minimum units.
b. Calculate a first resource allocation index (RA_index) as

$$RA\_index ( l , i ) = i + {\sum }_{k = 1}^{l - 1} ⌊ \frac{N}{k} ⌋ ,$$

where l and i are branch index and resource index within the branch, respectively, and └.┘ corresponds to floor-operation.
c. (optional step 1) Define N2 for the second cluster: In an embodiment the frequency separation between two clusters is limited to a predetermined maximum value, N2. In this example we define that N2 ∈ jM, where j is a pre-defined positive integer. Furthermore, we define that the first and second clusters are allocated from the same VRB-tree.

The second resource allocation index RA_index2, which is the RA index for the second cluster, is defined as

$$RA\_index2 ( {l}_{2} , {i}_{2} ) = {i}_{2} + {\sum }_{k = 1}^{{l}_{2} - 1} ⌊ \frac{N 2 + 1}{k} ⌋ ,$$

where l₂ and i₂ are branch index and relative resource index within the branch, respectively. Calculation of those resources starts at the point where the first cluster ends. (for example, i₂ is the starting position of the second cluster relative to the starting point of the first cluster).
d. (optional step 2 after step c above) Define L as the maximum relative branch index of the second cluster based on l₁:

$$RA\_index2 ( {l}_{2} , {i}_{2} ) = {i}_{2} + {\sum }_{k = 1}^{{l}_{2} - 1} ⌊ \frac{N }{( k + {l}_{1} - 2 - ⌊ L \text{/} 2 ⌋ ) \% K + 1} ⌋$$

where l₂ is the relative branch level of 2^{nd} cluster compares to that of 1^{st} cluster, and % is the function of mod. K is the maximum branch index.
e. (optional step 3 after c & d above) Define N2 as the maximum distance between two clusters in the unit of M.

$$RA\_index2 ( {l}_{2} , {i}_{2} ) = {i}_{2} + {\sum }_{k = 1}^{{l}_{2} - 1} ⌊ \frac{N 2 + 1 }{( k + {l}_{1} - 2 - ⌊ L \text{/} 2 ⌋ ) \% K + 1} ⌋$$

where l₂ and i₂ are relative branch index and relative resource index within the branch, respectively. K is the maximum branch index.
f. (optional step 4) Differential RA in terms of allowed resource index: R₁ and R₂ are resource indexes for the first and second clusters, which in an exemplary embodiment are calculated using the original formula

$$( {i}_{2} + {\sum }_{k = 1}^{{l}_{2} - 1} ⌊ \frac{N }{k} ⌋ ) .$$

In this embodiment the cluster with the smaller resource index is considered as the first cluster. The corresponding resource allocation index for the first cluster, RA_index1, can then be formulated as

RA_index1=min([R₁ R₂]).
The resource allocation index for the second cluster, RA_index2, is given as

RA_index2=max([R₁ R₂])−RA_index1−1.
g. (optional step 4) Differential RA in terms of allowed tree branch: In this exemplary embodiment the maximum cluster separation is defined by means of higher layer configured parameter ΔL, which is the starting branch for the second cluster with respect to the first cluster (in terms of maximum number of cluster tree-branches). The second resource allocation index, RA_index2 can by example be defined following the logic of the first cluster as:

$$RA\_index2 ( {l}_{1} , {l}_{2} , {i}_{i} ) = {i}_{2} + {\sum }_{k = max ( ( {l}_{1} - Δ L ) , 1 )}^{{l}_{2} - 1} ( ⌊ \frac{N }{k} ⌋ ) ,$$

where l₁ and l₂ correspond to the branch indexes of the respective first and second cluster, and i₂ is the resource index within the branch.

The network signals the RA_index and the VRB configuration (N and/or N2 and/or L) to the UE to allocate the first and second resource clusters for the UE's uplink transmissions.

In a second implementation the clustered resource allocation index is decoded at the UE by the UE deriving the parameters (l,i) based on the received RA_index and VRB configuration (N or N2). Following is one exemplary logic by which the UE can decode in this manner:

```
sigma=0
for l=1:K
    i=RA_index−sigma
    sigma=sigma+sigma(l)
    if RA_index<sigma
        break
    end
end
```

where sigma(l) equals to

$$⌊ \frac{N }{l} ⌋$$

with the first cluster. It is noted that in the case decoding is applied to option g, the then parameter 1 starts from max((l₁−ΔL),1).

If optional step 1 is on (the relative source index):

$$sigma ( l ) = ⌊ \frac{N 2 + 1 }{l} ⌋$$

for the second cluster. If optional step 2 is on (the relative VRB tree branch):

$$sigma ( l ) = ⌊ \frac{N }{l + {l}_{1} - 2 - ⌊ L \text{/} 2 ⌋ ) \% K + 1} ⌋ .$$

If both optional steps 1 and 2 are on (relative VRB tree branch+relative source index):

$$sigma ( l ) = ⌊ \frac{N }{l + {l}_{1} - 2 - ⌊ L \text{/} 2 ⌋ ) \% K + 1} ⌋ .$$

Second embodiment: The second embodiment for how to further reduce possible cluster positions employs a vector of cluster size options k={k₀, k₁, . . . , k_{K}}. If the first cluster has cluster size kᵢ, then the size of the second cluster is restricted to a maximum selected from the set {kᵢ₋ₓ, . . . , kᵢ₊ₓ}. In an exemplary embodiment, x=1 and the cluster size options for the second cluster are at maximum {kᵢ₋₁, kᵢ, kᵢ₊₁}. By activating the optional step 2 in this second embodiment and setting for example L=2x+1, the branch difference between two clusters are limited (normally optional steps 1 and 2 are activated together although they can be separately configured).

The following indexing scheme for clustered resource allocation can be employed to further reduce signaling overhead.
a. Define 3 portions within RA signaling. A first portion defines the first cluster starting position in PRB granularity of N₁=L₁M. The second portion defines the second cluster starting position in PRB granularity of N₂=L₂M relative to the position of the first cluster. And the third portion defines cluster size kᵢ for both first and second clusters as well as a refinement for the first or second cluster positions when L₁ and/or L₂ are larger than 1.
b. Calculate resource allocation index

i₁=└(P₁−O)/N₁┘ for portion 1, and

i₂=└(P₂−(i₁−O)/N₂┘ for portion 2;
where P₁ and P₂ are cluster starting positions for the first and second clusters, respectively.
c. Calculate resource allocation index for the third RA portion as

```
i₃ = 2l₂ + l₁
if max(s₁,s₂) > 0
  i₃ = i₃ + s₂ + 2l₂ + 3K + 1
  if s₁ = 0
    i₃ = i₃ + s₂ + 2(l₂ − 1) + 3L₂ (L₁ − 1) / 2
  end
end
```

where l₁ and l₂ are cluster size indexes for k₁₁ and k₁₂, s₁=P₁−i₁N₁ and s₂=P₂−i₂N₂ define cluster subposition within PRB granularity of N for the first and the second clusters, respectively,

To decode the resource allocation indexes at the UE, cluster subpositions s₁ and s₂ as well as cluster sizes k₁₁ and k₁₂ can be decoded based on received RA and configuration parameters L₁ and L₂ and K. For example, the following can be used as a specific decoding logic at the UE

```
s₁ = 0, s₂ = 0
l₂ = └(i₃ + 1) / 3┘
l₁ = i₃ − 2l₂
if i₃ > 3K
  i₃ = i₃ − 3K − 1
  r = L₂ / k₀
  if i₃ < 3L₂(L₁ − 1) / 2
    l₁ = 0, s₁ = 1
    l₂ = └i₃ / r┘, s₂ = i₃ − r * l₂
  else
    i₃ = i₃ − 3L₂(L₁ − 1) / 2
    l₂ = └i₃ / (2r − 2)┘, s₂ = └i₃ / 2┘mod(r − 1) + 1
    l₁ = i₃ mod 2 + l₂, s₁ = 0
  end
end
```

Now are presented some specific examples of the above aspects of the invention with reference to the drawings. FIG. 2 illustrates an exemplary VRB tree with K=8. The applicable cluster size options in this example are then k=[1, 2, . . . K=8]. The granularity is given by the parameter M. This same FIG. 2 VRB tree can be used whether M is 2, or 3, or 4, or any other positive integer value. For example, if M=2, then each kth row as illustrated at FIG. 2 represents 84 PRBs. If instead M=3, then each kth row as illustrated at FIG. 2 represents 126 PRBs. Each kth index on the same row represents a same number of PRBs, namely kM PRBs in that cluster. Since it is a cluster of PRBs being allocated rather than just one PRB according to these examples, M is an integer greater than one.

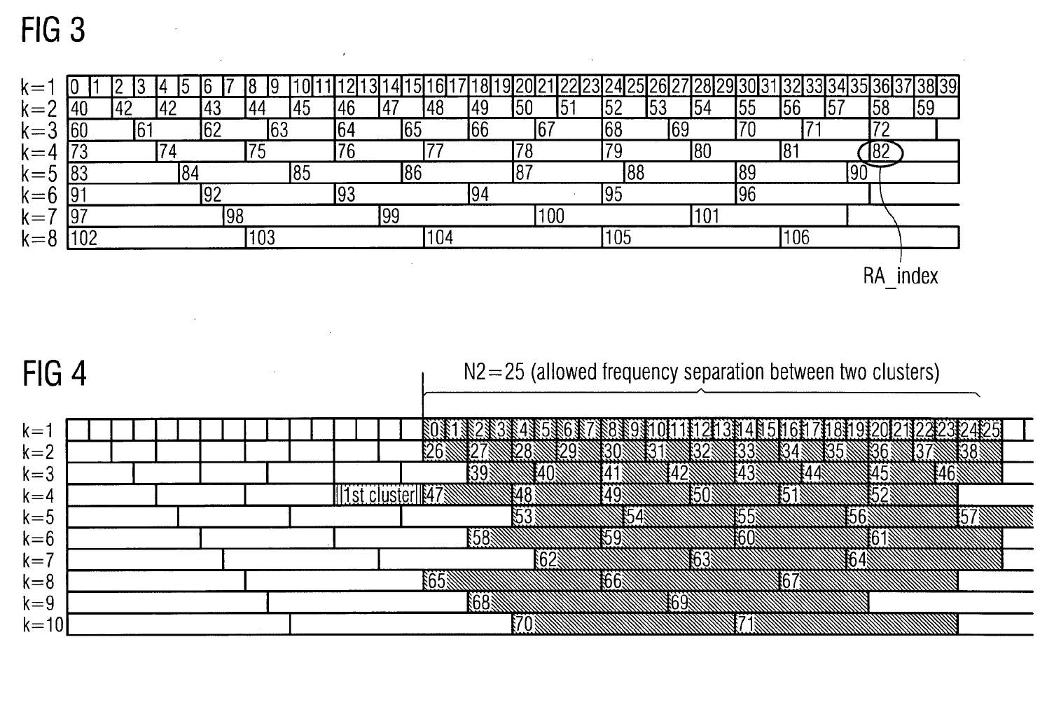

FIG. 3 shows a straightforward RA indexing scheme for the first cluster which is superimposed on top of the exemplary VRB structure from FIG. 2. The index number for each new kth row of the VRB tree continues from the final index number from the previous kth row, indexing higher from left to right and top to bottom. By example FIG. 3 highlights the RA_index 82. In the FIG. 3 example N=40 and so the index for row k=1 runs from 0 to 39 (or equivalently from 1 to 40).

For the second cluster, calculation of the VRB tree resources starts at the point where the first cluster ends. The principle is shown in FIG. 4, for which N2=25 in this example. As shown by example at FIG. 4, if the first cluster ends where indicated along row k=4 (the vertical line delineates the end of the first cluster), then the second cluster is restricted to begin only separated in frequency from the first cluster. This is shown at FIG. 4 by the shaded VRBs, whose start position begins at the end of the first cluster and whose end position is limited by the value of N2, which in this example is 25*M VRBs. N2 therefore gives the maximum separation between the first and second clusters, because it counts from the end of the first cluster and extends to the furthest VRB where the second cluster is allowed to be, which is also the furthest away in frequency the second cluster can be from the first cluster. From this it is clear that both the first and second clusters are allocated from the same VRB tree.

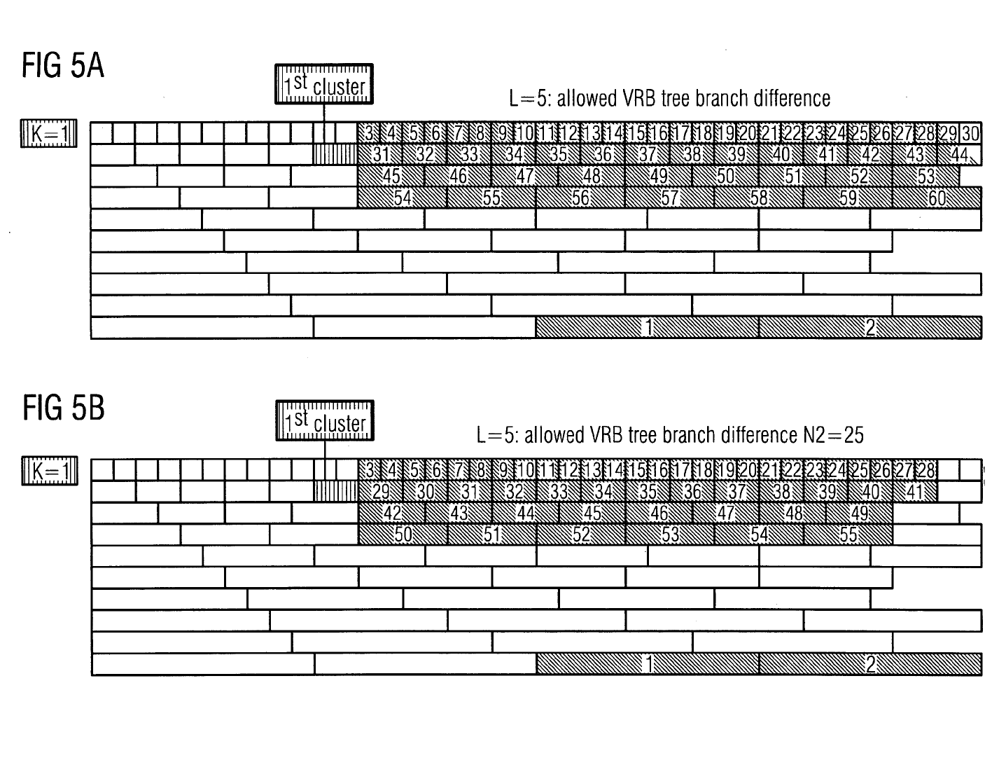

FIG. 5A illustrates an example VRB tree in which the area for the second cluster is shown in shading, all VRBs to the right of the end of the first cluster and further limited by L=5 relative branch index. That is, the second cluster is limited to lie within only L=5 of the available K total rows of the VRB tree at FIG. 5A. Because of the frequency separation from the first cluster, the second cluster in FIG. 5A is restricted to lie within only the darker shaded areas.

FIG. 5B is similar to FIG. 5A but FIG. 5B further limits where the second cluster can lie by imposing a value for N2, N2=25 in this case. The end of the first cluster restricts the second cluster to lie to the right of the delineated first cluster VRB. L=5 means that the second cluster can lie only within one of five k-rows. N2=25 means that the second cluster must lie within 25*M VRBs from the last VRB of the first cluster. Combining all these restrictions yields the dark shaded area of FIG. 5B in which the second cluster must lie.

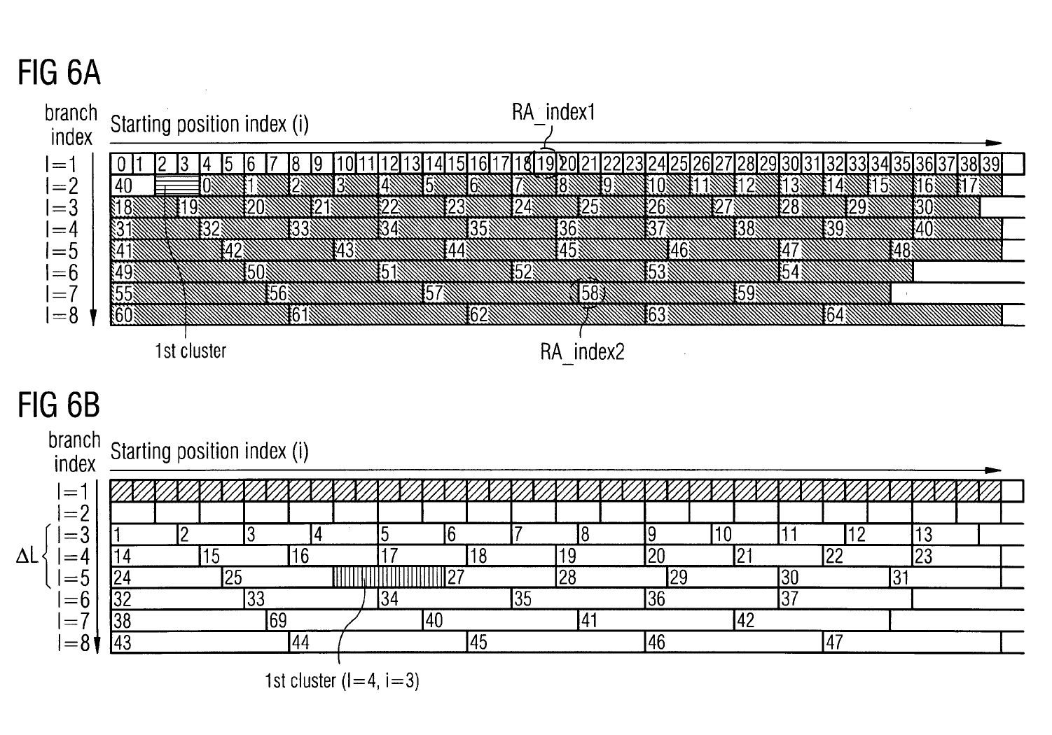

FIG. 6A illustrates an exemplary embodiment of the differential resource allocation approach, noted above at part f. The first index runs 0-40 and so there are 41 values allowed for the R₁ first cluster allocation, and the second index runs 0-64 and so there are 65 values allowed for the R₂ second cluster allocation. The annotations for RA_index1=19 and RA_index2=58 shown at FIG. 6A are merely illustrative of specific first and second cluster indices.

FIG. 6B illustrates a VRB with indexing according to the exemplary allowed tree branch option shown above under part g.

In an exemplary embodiment the VRBs are mapped to PRBs as follows. After decoding the RA_index at the UE, the first cluster can be mapped into physical PRB resources by determining the first cluster size, for example as C₁=(M·l₁), where l₁ is the VRB branch index of the first cluster. Then the UE determines the starting PRB, such as at (l₁·i₁·M)+O, where i₁ is the resource index within the VRB branch and O is the PRB offset of the VRB tree with respect to some pre-defined reference point (VRB #0 in these examples).

The second cluster can in an exemplary embodiment be mapped into physical PRB resources in the following way. If relative VRB branch indexing is closed, the UE can determine the second cluster size as C₂=(M·l₂). If instead relative VRB branch indexing is opened, the UE can determine the second cluster size as C₂=M·(l₂+l₁−└L/2┘−1), where l₂ is the VRB branch index of the second cluster. Then the UE can locate the starting PRB as

$$( ⌊ \frac{{i}_{1} * {l}_{1}}{{C}_{2} \text{/} M} ⌋ + {i}_{2} + 1 ) \cdot {C}_{2} + O ,$$

where i₂ is the relative resource index within the VRB tree.

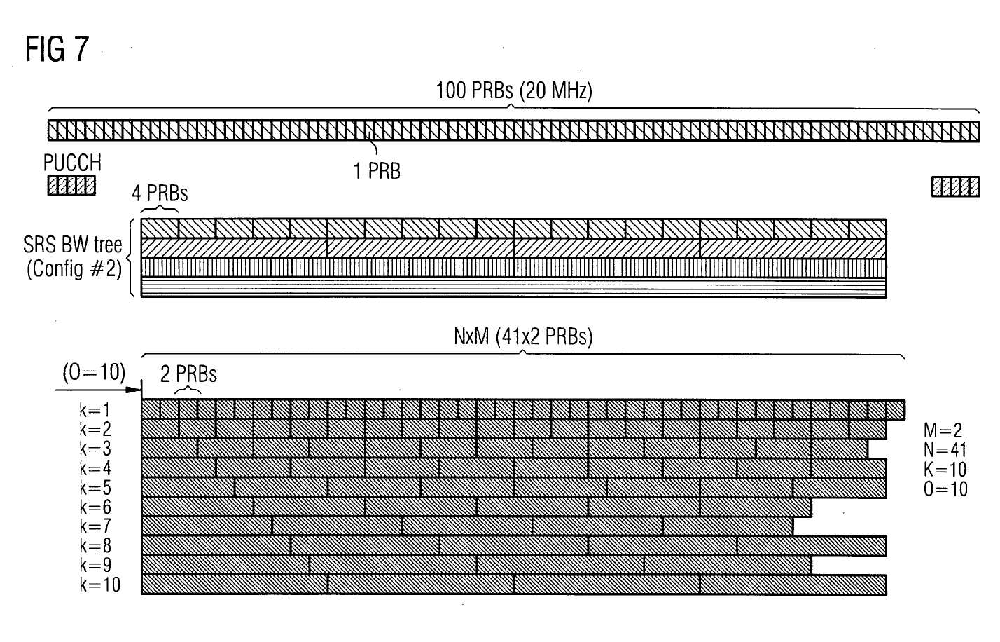

FIG. 7 shows an example of a proper configuration for a VRB tree, as configured by the following parameters. The allocation granularity is M {2, 3, 4} PRBs; there is one applicable branch from a total number of branches: k {1, 2, 3, 4, 6, . . . }, K; the starting position of the VRB tree is O; the size of VRB tree from the RA_indexing point of view is N; and the maximum allowed space between clusters, if used, is N2.

In one embodiment, all these parameters can be made system-specific and are configured by higher layers (for example, part of system information or radio resource control RRC signaling). In an alternative-embodiment, some of these parameters can be system specific (for example, M, k, N, N2, L) and some can be configured in a UE-specific manner.

If we assume there are a fixed number B of bits available for signaling the cluster allocations, then it is possible to divide the available number of RA bits (B) into cluster-specific portions. In one exemplary embodiment this dividing can be as follows for a dual-cluster case:

$${B}_{1} = ⌈ \frac{B}{2} ⌉$$

Number of bits reserved for the first cluster:
Number of bits reserved for the second cluster: B₂=B₁−B or

$${B}_{1} = ⌊ \frac{B}{2} ⌋$$

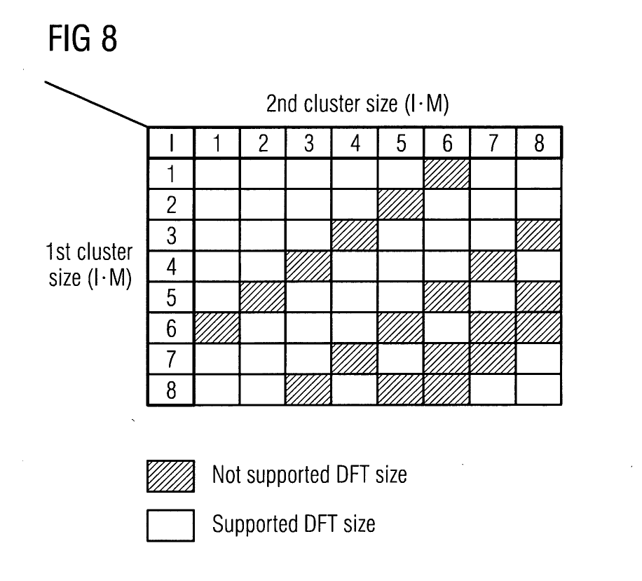

In LTE Release 8/9, discrete Fourier transform DFT complexity is limited. In practice this means that the size of the DFT (which means the number of allocated PRBs x 12) is factorized into a small number of prime numbers. In LTE Release 8/9, the DFT sizes are multiples of 2, 3 and 5. One way to retain this same limitation in dual-cluster embodiments of these teachings is to prevent certain dual-cluster combinations, for example making ‘illegal’ or disallowed certain RA combinations in LTE Release 10. This can be realized in such that a standard exillicitly prevents scheduling of those ‘illegal’ cluster combinations. Another choice is that proper UE operation is defined for those cases, for example such that UE just ignores those resource allocation grants that it considered illegal. FIG. 8 shows some exemplary illegal/disallowed RA combinations for unsupported DFT sizes, those lying along the darker shaded diagonals having (7, 11, 13, 14)*M PRBs allocated in total. All other RA combinations shown at FIG. 8 are ‘legal’ or allowed because they fall within the DFT complexity limitations. An alternative implementation is to forego DFT size limitation such as those used in LTE Release 8, in which case there would be no limitations in the usage of those combinations on the diagonals noted above.

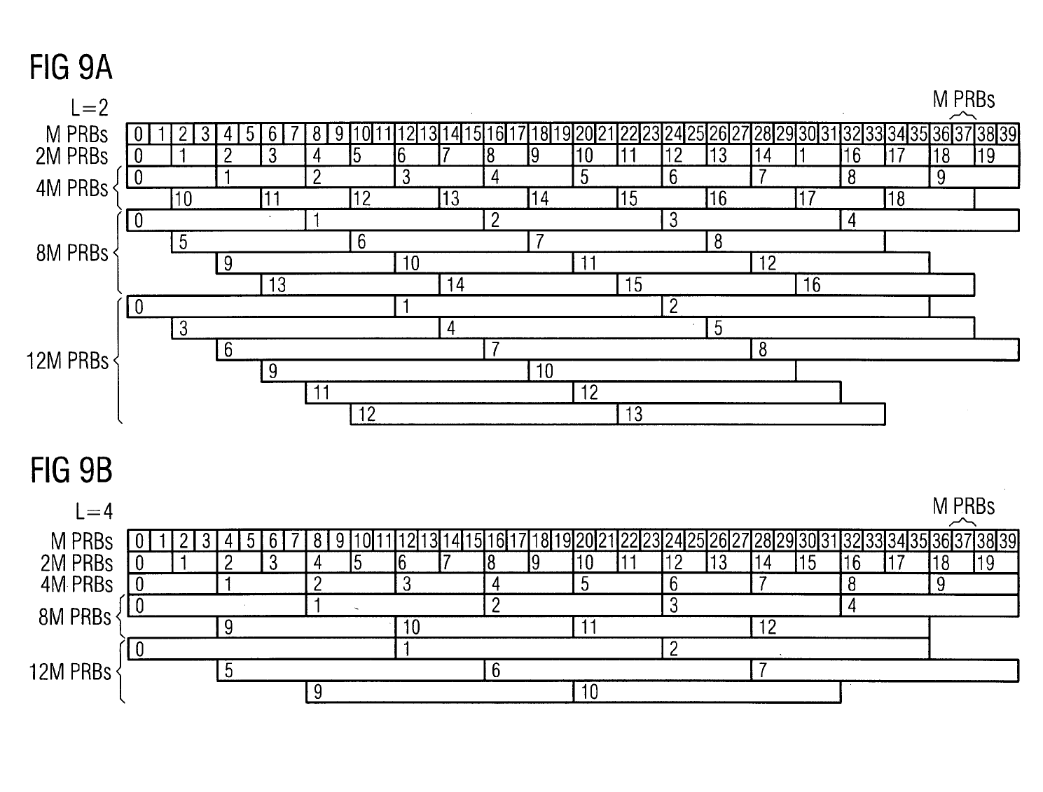

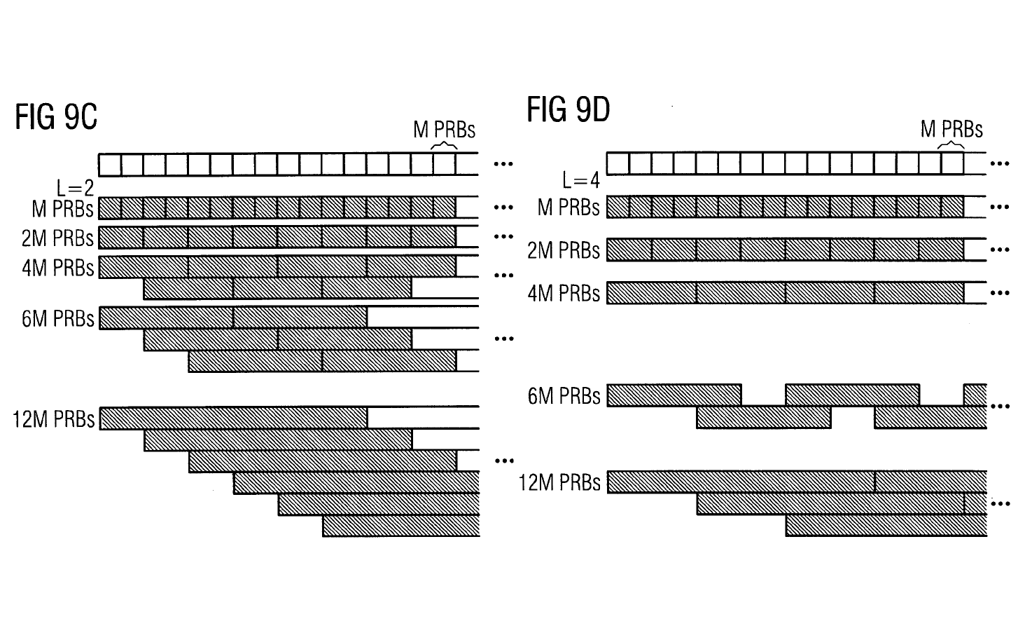

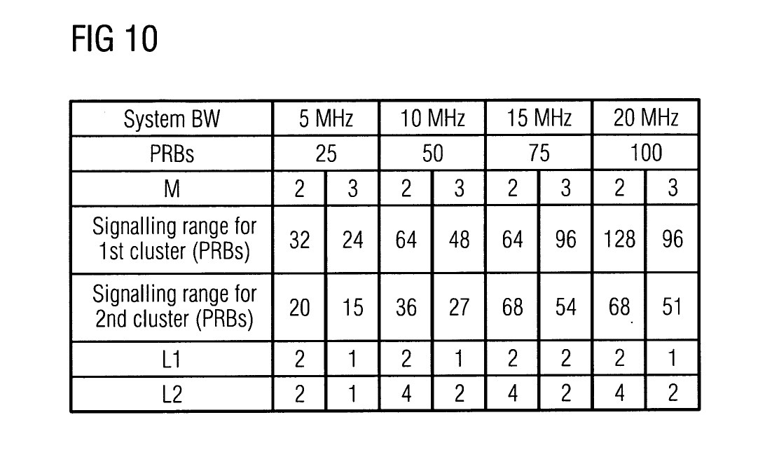

Now are presented examples for the second implementation. It should be noted that second implementation uses a VRB tree, as illustrated in FIG. 9A-B, that is different from VRB trees used in other presented implementations. For indexing of the resource allocation RA, using values of L₁ and/or L₂ larger than one saves signaling space because the starting position granularity is increased for larger L values. The starting position granularity is the minimum of L₁M and cluster BW. Applicable starting positions are illustrated at FIG. 10 for L=2 and L=4 and k={1, 2, 4, 6, 12}. Another exemplary configuration of L₁ and L₂ and corresponding signaling ranges for the first and second cluster are shown at FIGS. 9C-D, respectively.

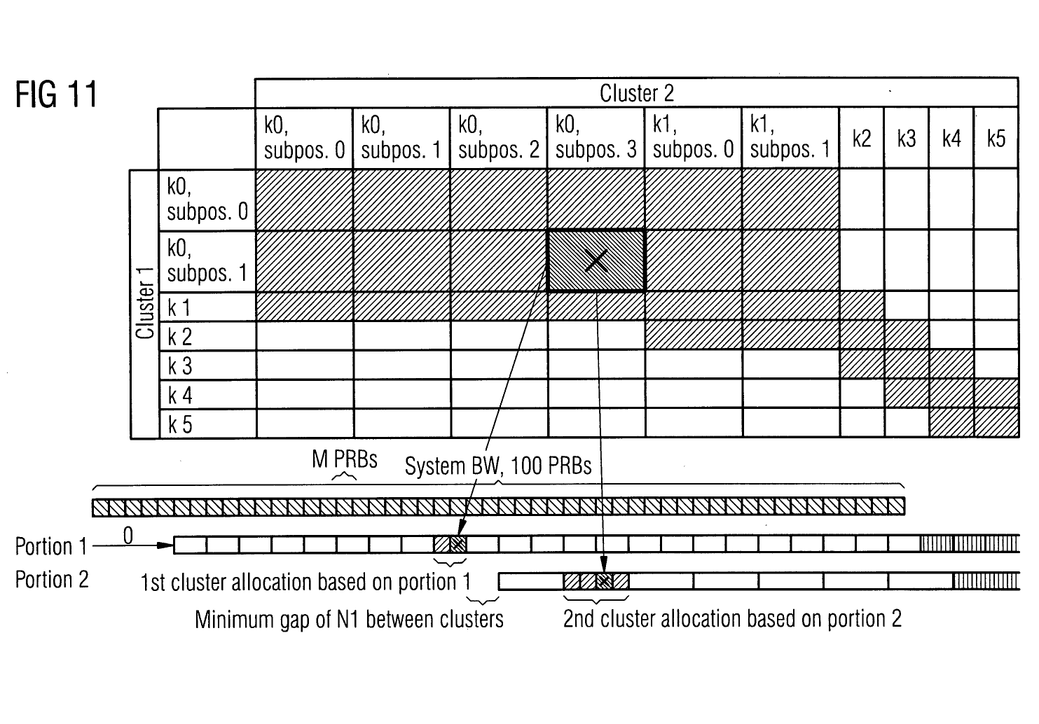

FIG. 11 illustrates an example of a cluster resource allocation, in which both the first and the second clusters have size of M PRBs. However, L₁ is set to 2 and L₂ is set to 4, so the cluster positions need to be refined by the use of subpositions s₁ and s₂ as shown nearer the bottom of FIG. 11.

After decoding the resource allocation indexes at the UE, the UE can map the first VRB cluster into physical PRB resources in the following way. First, the UE determines the cluster size in PRBs, such as by determining M*k₁₁, where k₁₁ is given by the cluster size index l₁. The UE then finds the starting PRB as P₁=N₁*i₁+s₁+O, where i₁ and s₁ are position and subposition indexes for 1^{st} cluster. For the second cluster, the UE determines the cluster size in PRBs, such as for example by computing M*k₁₂, where k₁₂is given by the cluster size index l₂. Then the UE finds the starting PRB as P₂=N₂*i₂+s₂+(i₁+2) N₁+O, where i₂ and s₂ are position and subposition indexes for the second cluster.

To do this there are of course a number of configuration parameters involved, namely the allocation granularity (for example M∈ {2, 3, 4} PRBs); the starting position offset (for example, O); the signaling granularity L₁ and L₂ for the first and second clusters, respectively; and the set of cluster size options (for example k={k₀, k₁, k₂, . . . , k_{K}}).

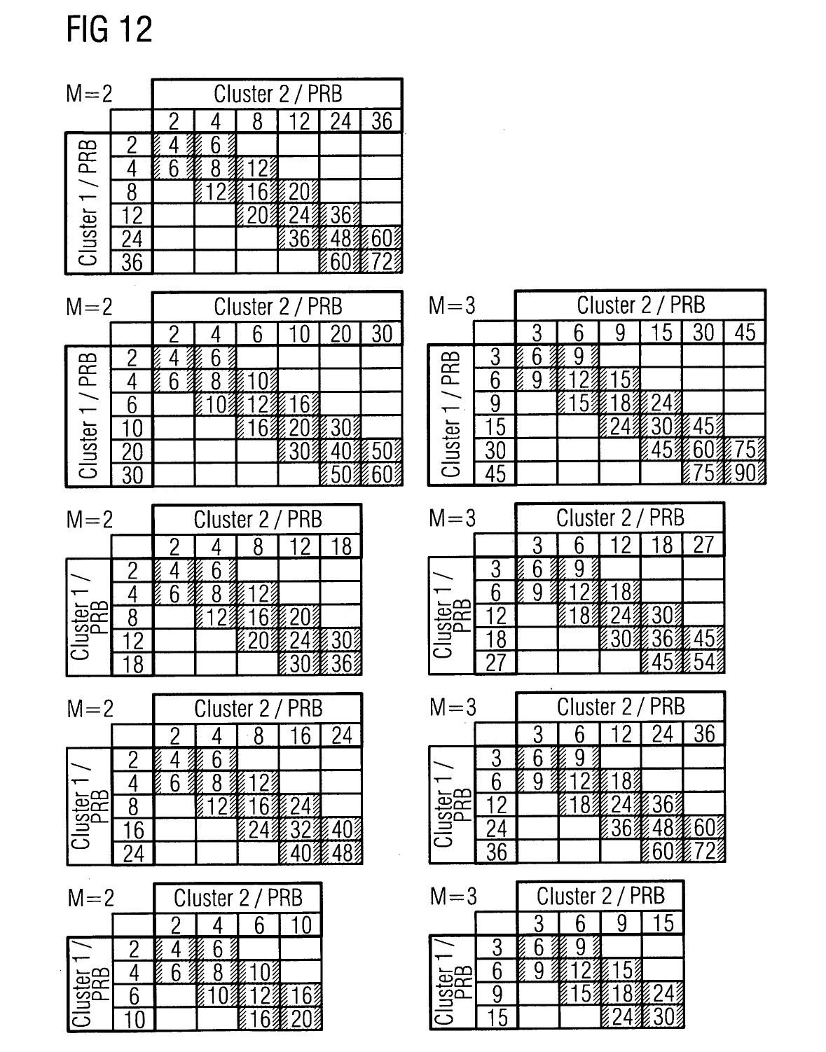

All these parameters can be made system-specific that are predetermined or configured by higher layers (for example, part of system information or RRC signaling). It is also possible to bundle (or link) L₁, L₂ and k. An exemplary set of cluster BW options and corresponding total BWs is shown in FIG. 12. The cluster bandwidth options are selected so that total resource allocation sizes match with the DFT sizes supported in LTE Release 8, but that is a convenience and not a limitation to the broader teachings of this invention. For the presented indexing, it is assumed that L₁∈ {{1,2}, L₂∈{1,2,4}, L₁≦L₂.

The above exemplary embodiments provide the following technical effects. The PUSCH RA can support a minimum cluster size of 2 PRBs regardless of the system bandwidth. It can support clustered resource allocation covering the entire bandwidth, which yields maximal support for PUCCH blanking where needed. The size of the clustered resource allocation matches with that of localized RA. Yet still a dynamic fall-back between clustered and localized allocation can be achieved by re-using a frequency hopping flag included in DCI Format 0, and the PDCCH overhead due to clustered allocation can be minimized while at the same time these embodiments avoid increasing the PDCCH blind decoding effort due to there being a clustered RA. The RA indexing scheme detailed above allows maximal utilization of SRS (sounding reference signal) resources, and allows one to keep the back-off at a predetermined level. The RA complexity is minimized for both encoding and decoding, and the scheduler complexity related to clustered PRB allocation is minimized. Additionally, the RA indexing scheme supports multiple configurations and is scalable.

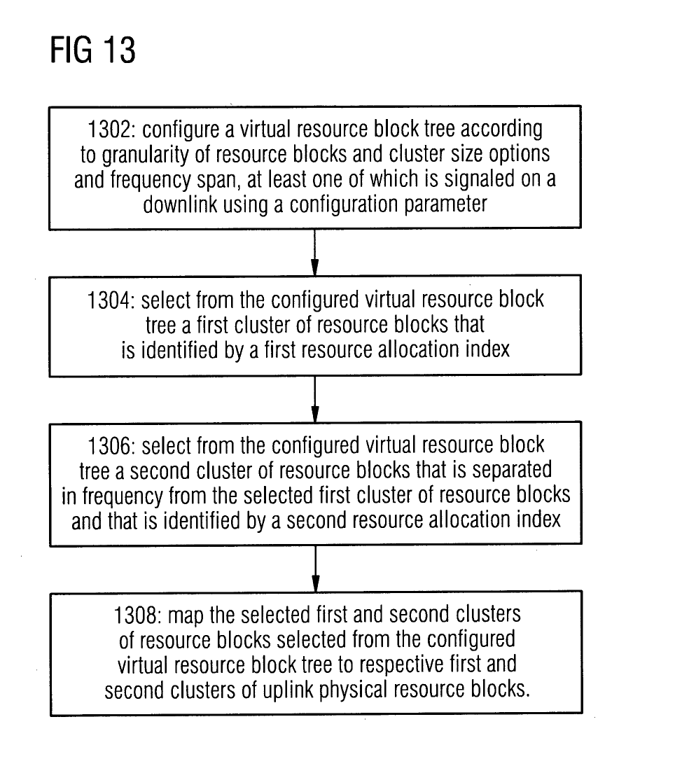

Embodiments of the invention include a method, an apparatus such as a network element/eNB or a user equipment UE or components thereof, and a computer program stored on a computer readable memory which when executed causes the apparatus to take actions such as those set forth above and briefly summarized at FIG. 13.

At block 1302 the apparatus configures a virtual resource block tree according to granularity of resource blocks and cluster size options and frequency span, at least one of those being signaled on a downlink by a configuration parameter. At block 1304 the apparatus selects from the configured virtual resource block tree a first cluster of resource blocks that is identified by a first resource allocation index. At block 1306 the apparatus selects from the configured virtual resource block tree a second cluster of resource blocks. This second cluster is separated in frequency from the selected first cluster of resource blocks, and the second cluster is identified by a second resource allocation index. And at block 1308 the apparatus maps the selected first and second clusters of resource blocks selected from the configured virtual resource block tree to respective first and second clusters of uplink physical resource blocks.

For the case in which the apparatus executing the steps of FIG. 13 is a network element, such a network element signals at least one of the block 1302 granularity of resource blocks and cluster size options and frequency span on the downlink, signals on the downlink the block 1304 and 1306 first and second resource allocation indexes, and the apparatus also allocates simultaneously the first and second clusters of uplink physical resource blocks on a physical uplink shared channel.

For the case in which the apparatus executing the steps of FIG. 13 is a user equipment, such a user equipment receives at least one of the block 1302 granularity of resource blocks and cluster size options and frequency span on the downlink, and receives on the downlink the block 1304 and 1306 first and second resource allocation indexes. It is such a user equipment to which is allocated simultaneously the first and second clusters of uplink physical resource blocks on a physical uplink shared channel, and the user equipment further transmits on the allocated first and second clusters of uplink physical resource blocks on the physical uplink shared channel.

In various exemplary but non-limiting embodiments detailed above: the granularity of resource blocks at block 1302 is M∈ {2, 3, 4} physical resource blocks and the cluster size options at block 1302 is an integer k multiple of M; the second resource allocation is relative to the first resource allocation with respect to at least one of frequency position, resource index and cluster size; and there are certain frequency band combinations of two clusters of resource blocks are made ‘illegal’ combinations where ‘illegal’ is due to at least one of total size of the two clusters is not supported, frequency separation of the two clusters exceeds a predefined maximum separation, and at least one of the clusters is located outside of a system bandwidth. Further as noted above, in an embodiment the resource allocation index is based on: the equation where

$$RA\_index ( l , i ) = i + {\sum }_{k = 1}^{l - 1} ⌊ \frac{N}{k} ⌋ ,$$

where l and i are branch index and resource index within the branch, respectively; and └·┘ corresponds to a floor operation.

In another exemplary but non-limiting embodiment detailed above, the calculated allocation index RA_index depends on a number N of M-sized units in the configured virtual resource block tree and on a first branch index.

In yet another exemplary but non-limiting embodiment detailed above, the second resource allocation index RA_index2 depends on the number N of M-sized units in the configured virtual resource block tree and on a second branch index and on a parameter L signaled on the downlink which denotes a maximum relative branch index of the second cluster of resource blocks.

In a still further exemplary but non-limiting embodiment detailed above, the second cluster of resource blocks is separated in frequency from the selected first cluster of resource blocks by a maximum separation defined by a parameter N2 signaled on the downlink. Instead of signaling N2 explicitly in downlink, it is also possible to specify proper resource allocation limitations for the second cluster. For example, resource allocations exceeding a pre-defined maximum separation (according to a predefined parameter N2) can be explicitly denied in the controlling wireless specification protocol, according to an exemplary embodiment. Alternatively, another exemplary embodiment defines proper UE operation such that UE just ignores those resource allocation grants considered illegal from the maximum frequency separation point of view.

In a further exemplary but non-limiting embodiment detailed above, the cluster size of the first cluster of resource blocks is a first integer kᵢ multiple of M and the cluster size options for the second cluster of resource blocks is constrained by kᵢ to be less than the integer k multiple of M.

An in a yet further embodiment there are a number B of bits reserved for signaling the first cluster and the second cluster, and of that total number B bits there is a number B₁ of bits reserved to signal the first cluster, in which

$${B}_{1} = ⌈ \frac{B}{2} ⌉ ,$$

and in which B is an integer.

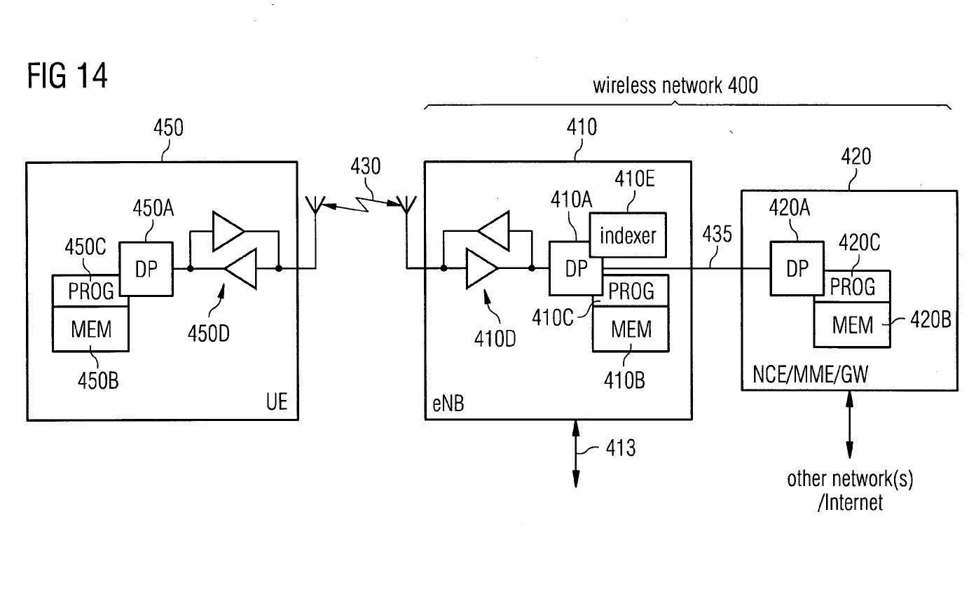

FIG. 14 is a simplified block diagram of various electronic devices and apparatus that are suitable for use in practicing the exemplary embodiments of this invention. In FIG. 14 a wireless network 400 is adapted for communication over a wireless link 430 with an apparatus, such as a mobile communication device such as the UE 450 to which resource clusters are allocated by a network access node, such as a Node B (base station), and by example a serving eNB 410. The network 400 may include a network control element (NCE) 420 which provides connectivity with a further network such as a telephone network and/or a data communications network (e.g., the internet).

The serving eNB 410 includes a controller, such as a computer or a data processor (DP) 410A, a computer-readable memory medium embodied as a memory (MEM) 410B that stores a program of computer instructions (PROG) 410C, and a suitable radio frequency (RF) transceiver 410D for bidirectional wireless communications with the UE 450 via one or more antennas. Typically the serving eNB 410 will have an array of antennas though single and multi-antenna implementations are within the scope presented herein. The eNB 410 is coupled via a data/control path 435 such as an S1 interface to the NCE 420. The eNB 410 may also be coupled to other access nodes via a data/control path 413, which may be implemented as an X2 interface.

The UE 450 also includes a controller, such as a computer or a data processor (DP) 450A, a computer-readable memory medium embodied as a memory (MEM) 450B that stores a program of computer instructions (PROG) 450C, and a suitable RF transceiver 450D for communication with the eNB 410 via one or more antennas. In general, the various embodiments of the UE 450 can include, but are not limited to, cellular telephones, personal digital assistants (PDAs) having wireless communication capabilities, portable computers (such as laptops, palmtops, tablets and the like) having wireless communication capabilities, music storage and playback appliances having wireless communication capabilities, gaming devices having wireless Internet access for multi-player interactive gaming, and other such portable units or terminals that incorporate combinations of such functions.

At least one of the PROGs 410C in the MEM 410B of the serving eNB 410 or other controlling apparatus is assumed to include program instructions that, when executed by the associated DP 410A, enable the device 410 to operate in accordance with the exemplary embodiments of this invention, such as those detailed above. That is, the exemplary embodiments of this invention may be implemented at least in part by computer software executable by the DP 410A of the eNB 410, or by hardware, or by a combination of software and hardware (and firmware). For completeness there is an indexer function 410E shown at the serving eNB 410 which is one means by which the serving eNB 410 determines the first and second cluster indices and associated parameters s as to implement the exemplary embodiments detailed above. Such an indexing function 410E may be hardware, software, or a combination of them both.

The computer readable MEMs 410B and 450B may be of any type suitable to the local technical environment and may be implemented using any suitable data storage technology, such as semiconductor based memory devices, flash memory, magnetic memory devices and systems, optical memory devices and systems, fixed memory and removable memory. The DPs 410A and 450A may be of any type suitable to the local technical environment, and may include one or more of general purpose computers, special purpose computers, microprocessors, digital signal processors (DSPs) and processors based on a multicore processor architecture, as non-limiting examples.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

The various blocks shown in FIG. 13 may be viewed, as method steps, and/or as operations that result from operation of computer program code, and/or as a plurality of coupled logic circuit elements constructed to carry out the associated function(s). At least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

1. A method, comprising:
configuring a virtual resource block tree according to granularity of resource blocks, cluster size options and frequency span with at least one configuration parameter signaled on a downlink;
selecting from the configured virtual resource block tree a first cluster of resource blocks that is identified by a first resource allocation index;
selecting from the configured virtual resource block tree a second cluster of resource blocks that is separated in frequency from the selected first cluster of resource blocks and that is identified by a second resource allocation index; and
mapping the selected first and second clusters of resource blocks selected from the configured virtual resource block tree to respective first and second clusters of uplink physical resource blocks.

2. The method according to claim 1, executed by a network element which signals the at least one configuration parameter related to the granularity of resource blocks, cluster size options and frequency span on the downlink, which signals on the downlink the first and second resource allocation indexes, and which allocates simultaneously the first and second clusters of uplink physical resource blocks on a physical uplink shared channel.

3. The method according to claim 1, executed by a user equipment which receives the at least one configuration parameter related to the granularity of resource blocks, cluster size options and frequency span on the downlink, which receives on the downlink the first and second resource allocation indexes, to which is allocated simultaneously the first and second clusters of uplink physical resource blocks on a physical uplink shared channel, and the method further comprising the user equipment transmitting on the allocated first and second clusters of uplink physical resource blocks on the physical uplink shared channel.

4. The method according to claim 1, which the second resource allocation is relative to the first resource allocation with respect to at least one of frequency position, resource index and cluster size.

5. The method according to claim 1 where certain frequency band combinations of two clusters of resource blocks are made ‘illegal’ combinations where ‘illegal’ is due to at least one of the following:
total size of the two clusters is not supported;
frequency separation of the two clusters exceeds a predefined maximum separation; and
at least one of the clusters is located outside of a system bandwidth.

6. The method according to claim 1, in which the granularity of resource blocks is M physical resource blocks, and the cluster size options is an integer k multiple of M;
wherein M is an integer that is pre-defined or signaled on a downlink.

7.-10. (canceled)

11. The method according to claim 6, in which the cluster size of the first cluster of resource blocks is a first integer kₗ multiple of M and the cluster size options for the second cluster of resource blocks is constrained by kᵢ to be less than the integer k multiple of M.

12. (canceled)

13. A memory storing a program of computer readable instructions that when executed by at least one processor result in actions comprising:
configuring a virtual resource block tree according to granularity of resource blocks and cluster size options and frequency span, at least one of which is signaled on a downlink;
selecting from the configured virtual resource block tree a first duster of resource blocks that is identified by a first resource allocation index;
selecting from the configured virtual resource block tree a second duster of resource blocks that is separated in frequency from the selected first cluster of resource blocks and that is identified by a second resource allocation index; and
mapping the selected first and second clusters of resource blocks selected from the configured virtual resource block tree to respective first and second clusters of uplink physical resource blocks.

14. The memory according to claim 13, in which the memory and the at least one processor are disposed in a network element which signals the at least one of granularity of resource blocks and cluster size options and frequency span on the downlink, which signals on the downlink the first and second resource allocation indexes, and which allocates simultaneously the first and second clusters of uplink physical resource blocks on a physical uplink shared channel.

15. The memory according to claim 13, in which the memory and the at least one processor are disposed in a user equipment which receives the at least one of the granularity of resource blocks and cluster size options and frequency span on the downlink, which receives on the downlink the first and second resource allocation indexes, to which is allocated simultaneously the first and second dusters of uplink physical resource blocks on a physical uplink shared channel, and the method further comprising the user equipment transmitting on the allocated first and second clusters of uplink physical resource blocks on the physical uplink shared channel.

16. The memory according to claim 13 where certain frequency band combinations of two clusters of resource blocks are made ‘illegal’ combinations where ‘illegal’ is due to at least one of the following:
total size of the two clusters is not supported;
frequency separation of the two clusters exceeds a predefined maximum separation; and
at least one of the clusters is located outside of a system bandwidth.

17. The memory according to claim 13, in which the granularity of resource blocks is M physical resource blocks, and the cluster size options is an integer k multiple of M;
wherein M is an integer that is pre-defined or signaled on a downlink.

18. (canceled)

19. An apparatus, comprising:
at least one processor; and
at least one memory storing computer program code;
the at least one memory and the computer program code configured, with the at least one processor, at least to:
configure a virtual resource block tree according to granularity of resource blocks and cluster size options and frequency span, at least one of which is signaled on a downlink;
select from the configured virtual resource block tree a first cluster of resource blocks that is identified by a first resource allocation index;
select from the configured virtual resource block tree a second cluster of resource blocks that is separated in frequency from the selected first cluster of resource blocks and that is identified by a second resource allocation index; and
map the selected first and second clusters of resource blocks selected from the configured virtual resource block tree to respective first and second clusters of uplink physical resource blocks,

20. The apparatus according to claim 19, in which the apparatus comprises a network element which is configured to:
signal the at least one of granularity of resource blocks and cluster size options and frequency span on the downlink;
signal on the downlink the first and second resource allocation indexes; and
allocate simultaneously the first and second clusters of uplink physical resource blocks on a physical uplink shared channel.

21. The apparatus according to claim 19, in which the apparatus comprises a user equipment which is configured to:
receive the at least one of granularity of resource blocks and cluster size options and frequency span on the downlink;
receive on the downlink the first and second resource allocation indexes; and
transmit on the allocated first and second clusters of uplink physical resource blocks on the physical uplink shared channel.

22. The apparatus according to claim 19, in which the second resource allocation is relative to the first resource allocation with respect to at least one of frequency position, resource index and cluster size.

23. The apparatus according to claim 19 where certain frequency band combinations of two clusters of resource blocks are made ‘illegal’ combinations where ‘illegal’ is due to at least one of the following:
total size of the two clusters is not supported;
frequency separation of the two clusters exceeds a predefined maximum separation; and
at least one of the clusters is located outside of a system bandwidth.

24. The apparatus according to claim 19, in which the granularity of resource blocks is M physical resource blocks, and the cluster size options is an integer k multiple of M;
wherein M is an integer that is pre-defined or signaled on a downlink.

25.-30. (canceled)
